(19) United States
(12) Patent Application Publication
(10) Pub. No.: US 2013/0339203 A1
(43) Pub. Date: Dec. 19, 2013

(54) RISK-BASED DYNAMIC GEO-LOCATION BASED REPLICATION OF SERVICES IN CLOUD COMPUTING

(71) Applicants: Marcos Dias de Assuncao, Sao Paulo (BR); Timothy M. Lynar, Victoria (AU); Kent C. B. Steer, Brunswick (AU); Marco Aurelio Stelmar Netto, Sao Paulo (BR); Cristian Vecchiola, Southbank (AU)

(72) Inventors: Marcos Dias de Assuncao, Sao Paulo (BR); Timothy M. Lynar, Victoria (AU); Kent C. B. Steer, Brunswick (AU); Marco Aurelio Stelmar Netto, Sao Paulo (BR); Cristian Vecchiola, Southbank (AU)

(73) Assignee: International Business Machines Corporation, Armonk, NY (US)

(21) Appl. No.: 13/525,738

(22) Filed: Jun. 18, 2012

(51) Int. Cl. G06Q 40/00; G06F 15/173

(52) U.S. Cl. 705/35; 709/226

(57) ABSTRACT

Dynamic provisioning of resources is employed to replicate capabilities and/or services in a distributed computing infrastructure to overcome potential disruptions in the capabilities and/or services. Predictive tools for weather forecasts, risk profile analysis based on geographical location of data/service centers, and historical data are employed to improve service resiliency. Further, for each local computing service that is considered for replication, the cost of disruption is compared with the total cost of replication to ensure that a computing infrastructure service provider is selected in a cost-efficient manner.

### BACKGROUND

The present disclosure relates to a methodology for risk-based dynamic geo-location based replication of services in cloud computing and a system for implementing the same.

Cloud computing provides storage, compute, and other information technology (IT) services on demand. Over the years, many organizations have either moved all, or part of, their applications and services to a cloud to provide, or employed cloud solutions to dynamically adjust, the IT infrastructure by integrating computing services according to surges and peak demands.

### BRIEF SUMMARY

Dynamic provisioning of resources is employed to replicate capabilities and/or services in a distributed computing infrastructure to overcome potential disruptions in the capabilities and/or services. Predictive tools for weather forecasts, risk profile analysis based on geographical location of data/service centers, and historical data are employed to improve service resiliency. Further, for each local computing service that is considered for replication, the cost of disruption is compared with the total cost of replication to ensure that a computing infrastructure service provider is selected in a cost-efficient manner.

According to an aspect of the present disclosure, a method of dynamically provisioning resources for a distributed computing infrastructure is provided. The method includes evaluating a risk, under at least one predicted environmental event, of not replicating at least one local computing service that an operator of the distributed computing infrastructure is expected to provide. The method further includes determining whether to replicate the at least one local computing service by adding at least one computing infrastructure service provider (CISP) to the distributed computing infrastructure based on evaluation of the risk. In addition, the method further includes adding at least one selected CISP to the distributed computing infrastructure if a determination to add the selected CISP is made.

According to another aspect of the present disclosure, a system for dynamic provisioning of resources for a distributed computing infrastructure is provided. The system includes one or more processor units in communication with a memory, and is configured to perform a method. The method includes a step of evaluating a risk, under at least one predicted environmental event, of not replicating at least one local computing service that an operator of the distributed computing infrastructure is expected to provide. The method further includes a step of determining whether to replicate the at least one local computing service by adding at least one computing infrastructure service provider (CISP) to the distributed computing infrastructure based on the evaluation of the risk. The method yet further includes a step of adding at least one selected CISP to the distributed computing infrastructure if a determination to add the selected CISP is made.

According to another aspect of the present disclosure, a system for dynamic provisioning of resources for a distributed computing infrastructure is provided. The system includes a computational resource selection module including a risk analysis module configured to evaluate a risk, under at least one predicted environmental event, of not replicating at least one local computing service that an operator of the distributed computing infrastructure is expected to provide, and configured to determine whether to replicate the at least one local computing service by adding at least one computing infrastructure service provider (CISP) to the distributed computing infrastructure based on the evaluation of the risk. The system further includes a service replication and computational infrastructure allocation module configured to receive instructions from the computational resource selection module and to add at least one selected CISP to the distributed computing infrastructure if the computational resource selection module generates an instruction to add the at least one selected CISP.

According to yet another aspect of the present disclosure, a non-transitory machine readable data storage medium embodying a computer program for dynamically provisioning resources for a distributed computing infrastructure is provided. The computer program includes instructions for performing a step of evaluating a risk, under at least one predicted environmental event, of not replicating at least one local computing service that an operator of the distributed computing infrastructure is expected to provide. The computer program further includes instructions for determining whether to replicate the at least one local computing service by adding at least one computing infrastructure service provider (CISP) to the distributed computing infrastructure based on evaluation of the risk. In addition, the computer program includes instructions for adding at least one selected CISP to the distributed computing infrastructure if a determination to add the selected CISP is made.

### BRIEF DESCRIPTION OF THE SEVERAL VIEWS OF THE DRAWINGS

FIG. 1 is a schematic diagram illustrating various components of a system for risk-based dynamic geo-location based replication of services in cloud computing according to an embodiment of the present disclosure.

FIG. 2 is a flow chart illustrating various steps for implementing a method for risk-based dynamic replication of services in cloud computing according to an embodiment of the present disclosure.

FIG. 3A is a first part of a flow chart for selecting computing infrastructure service providers for each local computing service to be replicated according to an embodiment of the present disclosure.

FIG. 3B is a second part of the flow chart for selecting computing infrastructure service providers for each local computing service to be replicated according to an embodiment of the present disclosure.

FIG. 4 is a schematic diagram illustrating the expansion of a cloud computing infrastructure according to an embodiment of the present disclosure.

### DETAILED DESCRIPTION

As stated above, the present disclosure relates to a methodology for risk-based dynamic geo-location based replication of services in cloud computing and a system for implementing the same. Aspects of the present disclosure are now described in detail with accompanying figures. The drawings are not necessarily drawn to scale.

As used herein, “cloud computing” refers to the delivery of computing hardware, computing software, and/or storage capacity as a service to a heterogeneous community of end-recipients.

As used herein, a “cloud” refers to a set of all infrastructures employed to provide a service of cloud computing.

As used herein, “grid based computing” or “grid computing” refers to a form of distributed and parallel computing, whereby a virtual computer includes a cluster of networked, loosely coupled computers acting in concert to perform very large tasks.

As used herein, an “alternative infrastructure” refers to any infrastructure that is not part of a cloud with respect to which the alternative infrastructure is referred.

As used herein, a “computing service” can be any service that cloud computing can provide.

As used herein, a “local computing service” is a computing service provided within a geographically limited region smaller than the entire earth.

In broad terms, a system and a method to dynamically replicate services of a distributed computing system on an alternative infrastructure are provided according to embodiments of the present disclosure. As used herein, a distributed computing system refers to any system including multiple autonomous computers that communicate through a computer network in order to achieve a common goal. Distributed computing systems include, for example, cloud and grid based computing systems. Dynamical replication of services of a distributed computing system can compensate for, and/or mitigate the damage caused by, predicted disruptions of a company's physical computing infrastructure. Dynamical replication of services of the distributed computing system can use alternative computing infrastructure technologies, environmental forecasts, data centre geographic location information, and historical data, in order to increase service availability and delivery.

According to an aspect of the present disclosure, the dynamic provisioning capabilities that characterize distributed computing infrastructure such as cloud and grid computing services are leveraged to elastically shape the company's physical infrastructure and provide resiliency as a service.

A feature of the present disclosure employed to provide the dynamic provisioning capabilities includes risk-based analysis of service replication or migration.

Another feature of the present disclosure employed to provide the dynamic provisioning includes the use of environmental event forecasts, such as weather forecasts, and geographic location information in order to determiner where services need to be replicated and to select a computing infrastructure service provider. This feature can be useful in case of natural and man-made disasters, which are usually geographically located. Other environmental event forecasts can include, but are not limited to, natural phenomena, such as storms, bushfires, and floods. Such man-made or natural environmental events can create disruptions that might make system's services unavailable or unreachable. For example, interruption of communication lines and network connections can cause the system services unavailable. Because many of the environmental events are geographically located, it is possible to minimize the impact of the environmental events by making potentially affected services redundant on demand.

Yet another feature of the present disclosure employed to provide the dynamic provisioning capabilities includes the use of historical data on environmental events (such as weather events) and service demands to aid the evaluation of a potential site (or location) to which services must be replicated or migrated.

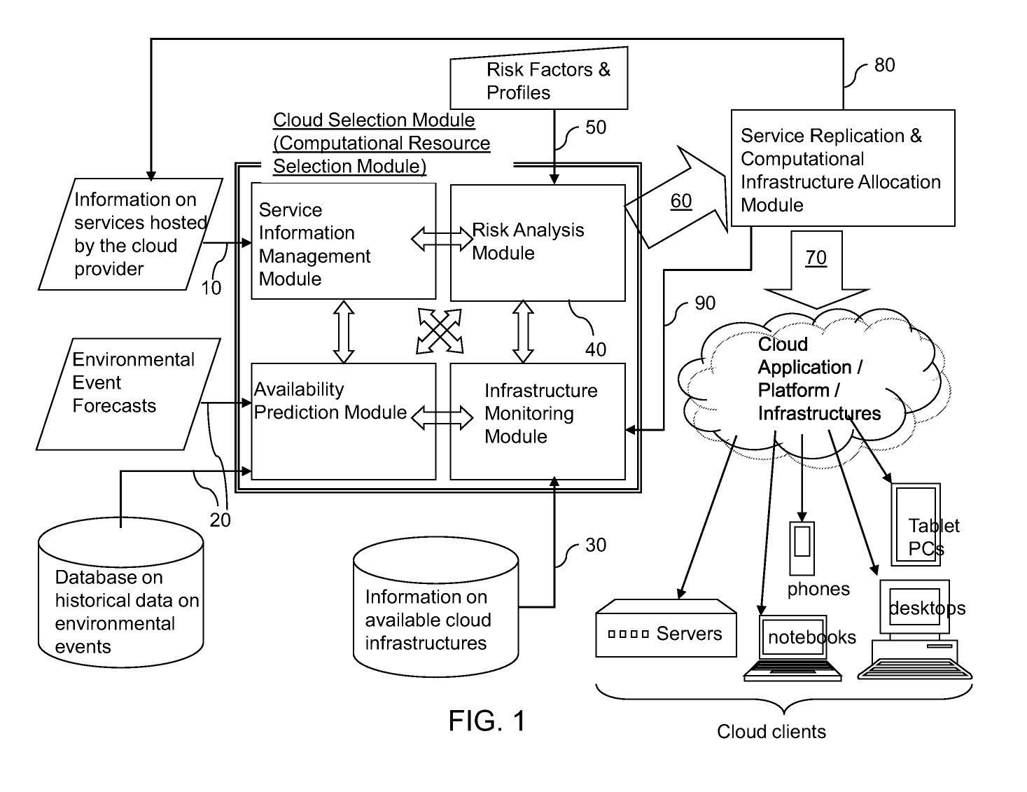

Referring to FIG. 1, a schematic diagram illustrates various components of a system for risk-based dynamic replication of services in cloud computing according to an embodiment of the present disclosure. The system can be employed by a cloud provider who provides one or more cloud application services, cloud platform services, and/or cloud infrastructure services in order to increase availability and reliability of the services that the cloud provider offers. While an embodiment of the present disclosure is described herein for the case of cloud computing, the embodiments of the present disclosure can also be applied to any system that employs a distributed computing infrastructure.

The system can include a computational resource selection module (which is also referred to as a “cloud selection module” in embodiments applied to cloud computing). The computational resource selection module can include a service information management module, an availability prediction module, an infrastructure monitoring module, and a risk analysis module. Each of these modules can include one or more processors in communication with a memory and configured to run programming instructions for performing various steps that the module enables.

Further, the system includes a service replication and computational infrastructure allocation module, which is configured to receive instructions from the computational resource selection module and to add at least one selected computing infrastructure service provider (CISP) to the distributed computing infrastructure. In one embodiment, the distributed computing infrastructure can be provided as a cloud computing infrastructure configured to provide one of more of infrastructure as a service (IaaS), platform as a service (PaaS), and software as a service (SaaS). As used herein, a CISP refers to any service provider that provides a computing infrastructure service in the form or Iaas, PaaS, SaaS, or any combination thereof. A CISP may be within a same company as the operator of the distributed computing infrastructure, or can be a different company from the operator of the distributed computing infrastructure.

Infrastructure as a service is a cloud service model in which a cloud provider offers computers (as physical machines or as virtual machines), storage, firewalls, load balancers, and networks. Platform as a service is a cloud service model in which a cloud provider delivers a computing platform and/or solution stack typically including operating system, programming language execution environment, database, and web server. Software as a service (SaaS) is a cloud service model in which a cloud provider installs and operates application software in the cloud and cloud users access the software from cloud clients. The various services that a cloud provides can be accessed by various computing devices known in the art, including, but not limited to, servers, notebooks, desktops, tablet PC's, and phones.

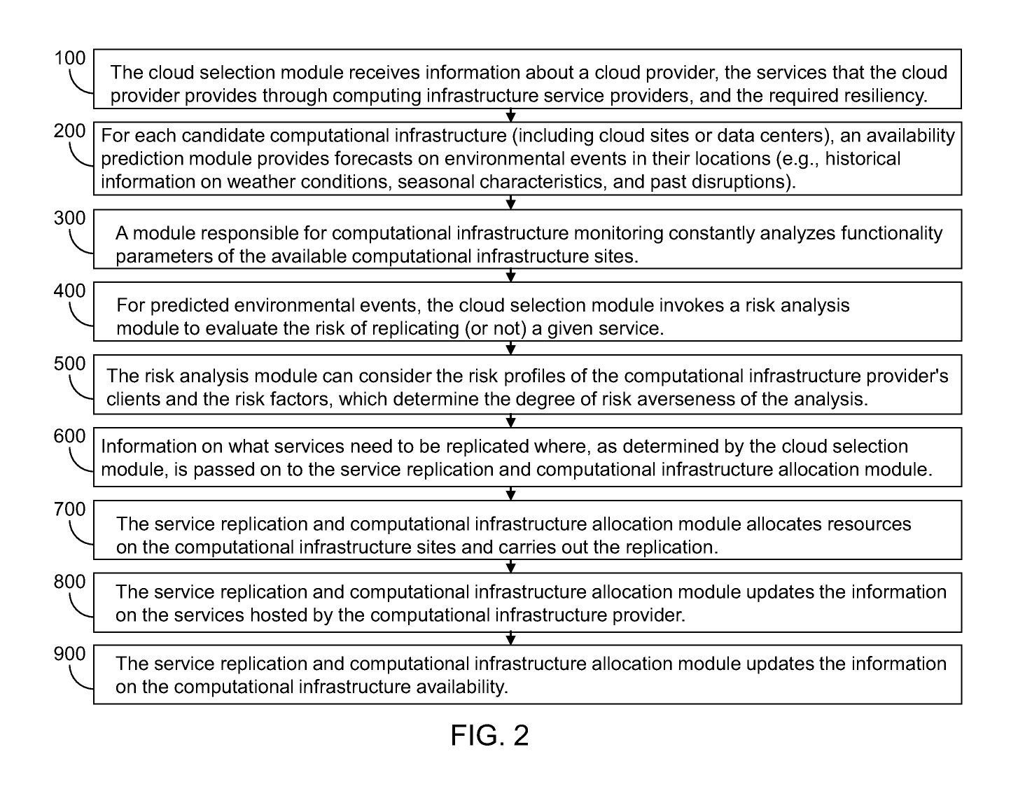

The system of FIG. 1 can be operated to dynamically provision resources for the distributed computing infrastructure employing the steps shown in the flow chart of FIG. 2. Various operations performed on the system of FIG. 1 to implement the various steps of the method of FIG. 2 are schematically represented in FIG. 1 with numerals representing the respective operations.

The computation resource selection module can select a location or infrastructure service in which services are to be replicated employing the various modules therein. Referring to operation 10 of FIG. 1 and step 100 of FIG. 2, the service information management module within the computational resource selection module is configured to monitor information on services hosted by the operator of the distributed computing infrastructure. The service information management module can receive information about the operator of the distributed computing infrastructure (e.g., a cloud provider), the services provided by the operator of the distributed computing infrastructure through at least one computing infrastructure service provider (CISP), and the required resiliency levels associated with each service that the operator of the distributed computing infrastructure is expected to maintain. The information on the services hosted by the service provider can be provided to the service information management module as input data.

In one embodiment, the distributed computing infrastructure is a cloud computing infrastructure. In one embodiment, the services provided by the operator of the distributed computing infrastructure through at least one computing infrastructure service provider (CISP) can include at least one local computing service. As used herein, a “local computing service” is a service that an operator is obligated to provide within a geographically limited region that is smaller than the entire world. The geographically limited region may be within a continent, within a country, within a state, or within any geographically defined region. In one embodiment, the at least one local computing service includes at least one of cloud application service, cloud platform service, and cloud infrastructure service.

Referring to operation 20 of FIG. 1 and step 200 of FIG. 2, the availability prediction module is configured to determine availability of the at least one local computing service under at least one predicted environmental event. As used herein, an environmental event refers to any natural or man-made event that can be predicted and can affect local computing services provided by a distributed computing infrastructure. The at least one predicted environmental event can include, but is not limited to: weather events, a geothermal activity (e.g., volcanic eruptions), a geomechanical activity (e.g., earthquakes), or a natural phenomenon derived from a geothermal activity (e.g., volcanic ash dispersion derived from a volcanic eruption) or a geomechanical activity (e.g., a tsunami derived from an earthquake), and a man-made event that disrupts operation of at least one component of the distributed computing infrastructure (e.g., a war).

Because each of the local computing services is limited within the corresponding geographically limited region, each predicted environmental event is analyzed to determine the corresponding region of impact, i.e., areas that are affected by the predicted environmental event. In one embodiment, the availability prediction module can perform calculations only when the region of impact affects a local computing service. The availability prediction module can calculate predicted values of availability given the input that specifies various parameters of the predicted environmental effect.

Environmental event forecasts are provided as the input to the availability prediction module. Further, the availability prediction module can include, or be in communication with, a database on historical data on environmental events. The database on historical data on environmental events can include, for example, historical information on weather conditions, seasonal characteristics, and past disruptions. Employing the environmental event forecasts and the database on historical data on environmental events, the availability prediction module can provide forecasts on the effects on the distributed computing infrastructure and the local computing services of the predicted environmental events within the region of impact of the predicted environmental events. For example, the availability prediction module can make availability predictions for each candidate computational infrastructure (such as cloud sites or data centers) and the local computing services within the region of impact of the predicted environmental events. For example, an availability index can be derived based on previous experience on the impact of certain weather events on information technology (IT) infrastructure of the considered region. For instance, strong seasonal raining that affects specific geographic regions can be considered to determine the availability index.

In one embodiment, the availability prediction module can be configured to invoke the operation of the risk analysis module only if an estimated probability of disruption of the at least one local computing service is greater than a predefined value.

Referring to operation 30 of FIG. 1 and step 300 of FIG. 2, the infrastructure monitoring module configured to monitor information on available infrastructures of the distributed computing infrastructure. The infrastructure monitoring module can constantly analyze functionality parameters of the available computational infrastructure sites within the distributed computing infrastructure. For example, the functional parameters of the available computational infrastructure sites can include, but are not limited to: the throughput of the computational infrastructure sites, the utilization of the computational infrastructure sites, and the capacity of the available resources at the computational infrastructure sites. The functionality parameters can be employed to select an alternative infrastructure over another alternative structure for replicating services in subsequent steps, e.g., at steps 400 and/or 500.

Referring to operation 40 of FIG. 1 and step 400 of FIG. 2, the risk analysis module is configured to evaluate a risk, under at least one predicted environmental event, of not replicating at least one local computing service that the operator of the distributed computing infrastructure is expected to provide. Further, the risk analysis module is configured to determine whether to replicate the at least one local computing service by adding at least one computing infrastructure service provider (CISP) to the distributed computing infrastructure based on the evaluation of the risk.

For example, under predicted extreme weather conditions, the computational resource selection module can invoke the risk analysis module to evaluate the risk of replicating or not replicating a given service. The risk of replicating includes the risk of incurring excessive cost during the process of replicating. The risk of not replicating includes the risk of a service disruption and accompanying financial and non-financial losses to the operator of the distributed computing environment.

Referring to operation 50 of FIG. 1 and step 500 of FIG. 2, the risk analysis module can consider the risk factors and profiles of the computational infrastructure provider's clients (i.e., the clients of the operator of the distributed computing infrastructure). The risk factors and profiles of the clients can be provided as an input to the risk analysis module. The risk factors and profiles of the clients can be employed to determine the degree of risk averseness of the analysis performed by the risk analysis module. Services having a high impact of disruption to the client can be classified as services having high risk averseness, and services having a low impact of disruption to the client can be classified as services having low risk averseness. The impact of disruption of services to the client may be measured in terms of any metric known in the art for measuring the impact of disruption in the client's business, including direct and indirect financial losses and intangible losses in good will. For example, in addition to financial estimates on the loss caused by service unavailability, metrics that can be used to measure disruptions and their impact on a client's business include, but are not limited to, mean time between failure (MTBF) and mean time to restore (MTTR).

In one embodiment, the risk analysis module is configured to determine an impact of disruption of the at least one local computing service to the operator, and to determine an estimated total cost of replicating the at least one local computing service by adding the at least one computing infrastructure service provider. Further, the risk analysis module can be configured to determine the probability at which the predicted environmental event is expected to disrupt the at least one local computing service. For example, risk assessment techniques, often used for IT security purposes, in which the incurred risk depends on threats, vulnerability and asset/service value can be adapted to compute the risk of replicating (or not replicating) a service set to an alternate infrastructure. In such a case, inclement weather conditions can be factored in as a potential threat that can compromise the well functioning of the IT infrastructure in consideration.

In one embodiment, the risk analysis module can be configured to compute an expectation value for a total financial cost of not replicating the local computing service, and to compare the expectation value with the estimated total cost of replicating the at least one local computing service. Any of the methods described above can be employed to compute the expectation value for the total financial cost of not replicating the local computing service.

In one embodiment, the risk analysis module can be configured to include, within the estimated total cost of replicating the at least one local computing service, the cost of adding the at least one computing infrastructure service provider to the distributed computing infrastructure, and the cost of operating the at least one computing infrastructure service provider for a duration of the at least one predicted environmental event.

In one embodiment, the risk analysis module can be configured to generate a list of available alternate computing infrastructure service providers (CISP's) for each selected local computing service among the at least one local computing service, and to compute a replication time needed to replicate the selected local computing service for each available alternate CISP among the list of available alternate CISP's. Further, the risk analysis module can be configured to calculate the estimated time until initiation of a possible disruption due to the at least one predicted environmental event. In addition, the risk analysis module can be configured to determine an estimated total cost of replicating the at least one local computing service only for available alternate CISP's having a replication time that is less than the estimated time until initiation of the possible disruption.

In one embodiment, the risk analysis module can be configured to compute an estimated duration of a possible disruption from at least one predicted environmental event. Further, the risk analysis module can be configured to determine an estimated total cost of replicating the at least one local computing service based on the computed estimated duration of the possible disruption.

In one embodiment, the risk analysis module can be configured, for each selected local computing service among the at least one local computing service, to generate a list of available alternate CISP's, and to compute a minimum total cost of replicating the selected local computing service employing an alternate CISP among the list of available alternate CISP's. The list of available alternate CISP's can be selected based on the geo-location of the CISP's so that the services provided by the CISP's within the list are not affected by the predicted environmental event.

In one embodiment, the risk analysis module can be configured to compute the minimum total cost by calculating, for each available alternate CISP among the list of available alternate CISP's, a total cost of replicating the selected local computing service employing the each available alternate CISP, and by selecting a minimum value among the calculated total costs of replicating the selected local computing service.

In one embodiment, the risk analysis module can be configured to include, within the total cost of replicating the selected local computing service to an available alternate CISP under consideration, the cost for replicating the selected local computing service to the available alternate CISP under consideration, and the cost for restoring the selected local computing service from the available alternate CISP under consideration.

In one embodiment, the risk analysis module can be configured, for each selected local computing service among the at least one local computing service, to generate an indexed list of available alternate CISP's based on predetermined specified criteria or predetermined business constraints. Further, the risk analysis module can be configured to set an initial value for an index for the indexed list of available alternate CISP's at an extremum (e.g., a minimum or a maximum), and to increment (in case the index is initially set at the minimum) or to decrement (in case the index is initially set at the maximum) the index until an available alternate CISP is found that is capable of providing the selected local computing service at a total cost of replicating the selected local computing service that is less than an expectation value for a total financial cost of not replicating the local computing service, or until all CISP's within the indexed list of available alternate CISP's are examined.

In one embodiment, the selection and replication processes consider the location of candidate CISP's, the amount of time that is required to move data and code from a cloud infrastructure to be replicated to a selected alternative infrastructure, the estimated loss in case of disruption, and the cost incurred in using the provider's services for the planned amount of time.

In one embodiment, the computational resource selection module can employ an algorithm that continually monitors the arrival of information on predicted environmental events such as weather forecasts. Once a forecast for a predicted environmental event is received, the availability prediction module can compute the likelihood of this event causing a disruption. If this likelihood is above a predefined threshold value, which can be specified by the system administrator or derived by the system based on historical data, the risk analysis module can compute the time left until the disruption and the duration of the disruption.

Subsequently, for each service and infrastructure service providers, the risk analysis module computes the cost of disruption, replication and restore. The risk analysis module can perform an analysis to check whether a replication to each infrastructure service provider is advantageous in various aspects including timing, reliability, robustness, and cost.

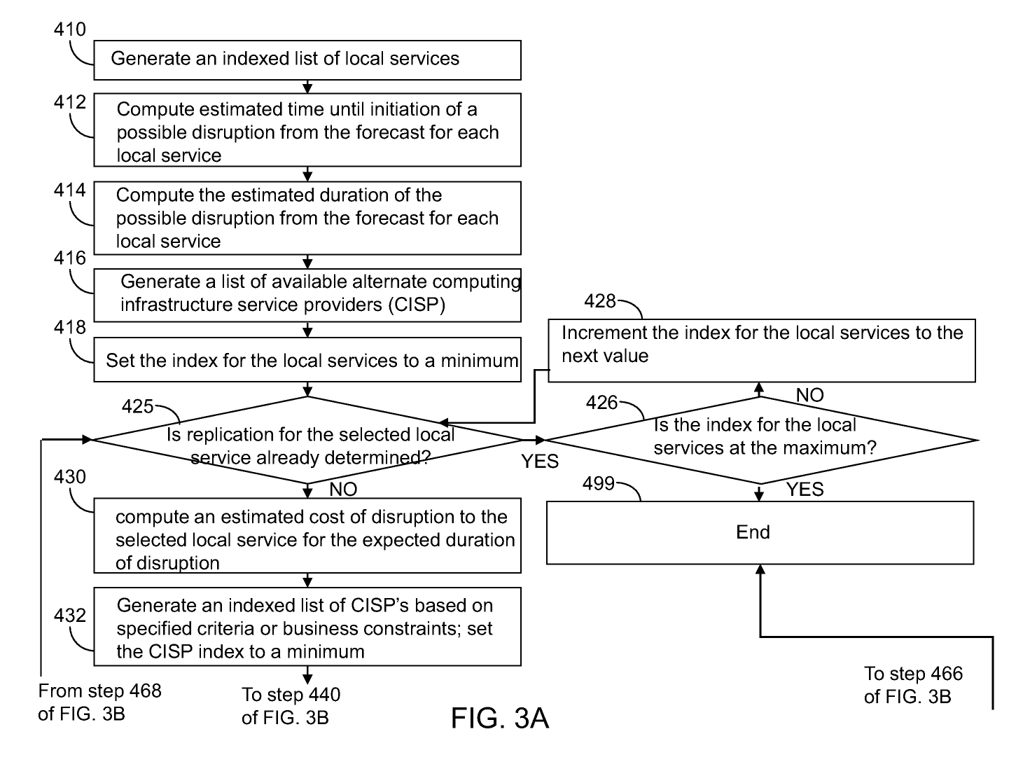

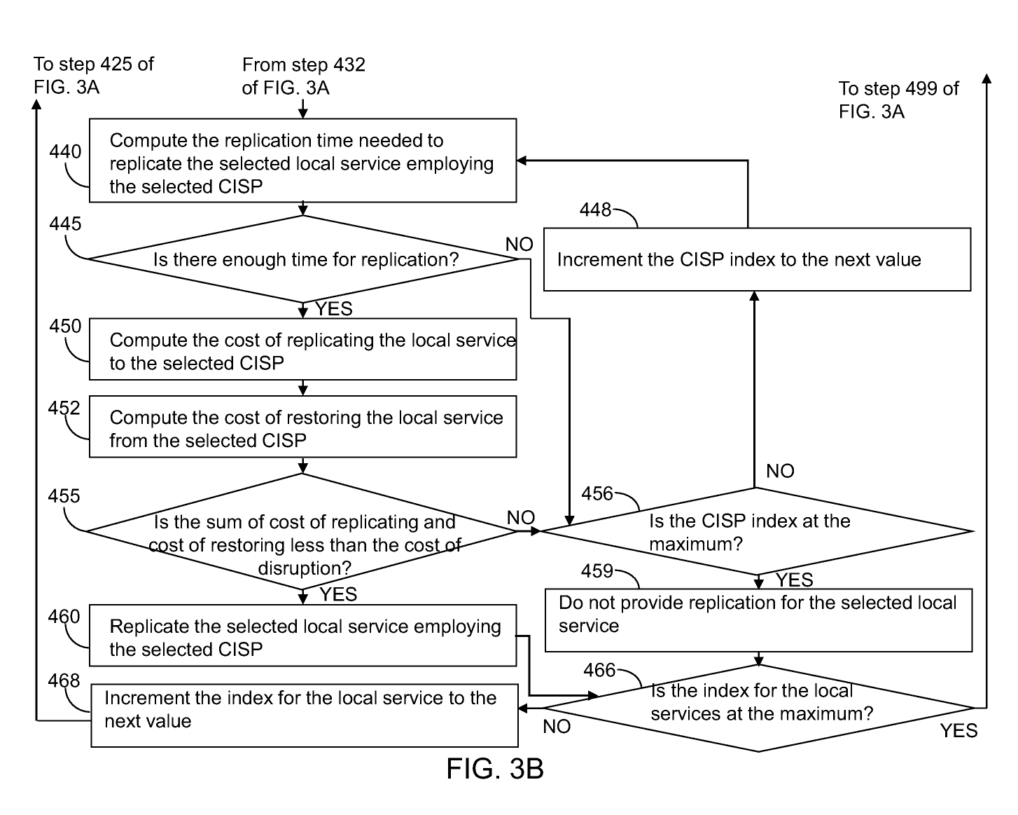

Referring to FIGS. 3A and 3B, a flow chart according to an embodiment of the present disclosure illustrates non-limiting examples of steps that can be employed by the risk analysis module to select computing infrastructure service providers (CISP's) for each local computing service to be replicated. In some embodiments, variations of the flow chart in which one or more steps are performed out of sequence or omitted can also be employed.

Referring to step 410, an indexed list of local computing services that is potentially affected by a predicted environmental event can be generated. For example, flooding is a condition that has affected many densely populated areas over the past few years, especially in developing countries. According to an embodiment of the present disclosure, upon a forecast of such an event, a list of infrastructures that are likely to be compromised can be determined, and a list of services that currently depend on such infrastructure for operation can be determined. The services in the list can be the candidates for replication.

Referring to step 412, an estimated time until initiation of a possible disruption from the forecast for each local computing service can be computed based on the forecast on the nature of the predicted environmental event. For example, the estimated time until initiation of a possible disruption can be calculated employing the data generated by the availability prediction module based on the parameters of the predicted environmental events (e.g., beginning of a severe weather condition or arrival of a tsunami).

Referring to step 414, the estimated duration of the possible disruption can be computed from the forecast for each local computing service. For example, the estimated duration of the possible disruption can be calculated employing the data generated by the availability prediction module based on the parameters of the predicted environmental events.

Referring to step 416, a list of available alternate computing infrastructure service providers (CISP) can be generated, for example, from publicly available database (e.g., phone book directory), a database (not shown) configured to store information on alternate CISP's, and/or by manual entry of information. The list of available CISP's can be indexed employing any algorithm known in the art.

Referring to step 418, the index for the local computing services can be set to a minimum value. Alternately, any systematic index changing method can be employed provided that all of the local computing services affected by the predicted environmental event can be processed during the subsequent steps to provide adequate service replication as determined by comparison of the total cost of replication and the cost of not replicating, i.e., the value of disruption of each service.

Referring to step 425, a determination can be made as to whether replication for the selected local computing service has already been determined. If the decision on whether to replicate the local computing service corresponding to the current index value has already been made, the process flow proceeds to step 426.

At step 426, a determination is made as to whether the index for the local computing services is at the maximum. If the indexing scheme employs any other algorithm than incrementing the value of the index from the minimum, a determination can be made as to whether there exists any local computing service for which a determination on whether to replicate the local computing service has not yet been made. If the value of the index is at the maximum, or alternately, if there is no other local computing service for which a decision on whether to replicate the local computing service has not yet been made, the process flow proceeds to step 499, at which the process flow terminates.

If the value of the index is not at the maximum, the process flow proceeds to step 428, at which the value of the index for the local computing services is incremented to the next value. Alternately, a new local computing service for which a decision on whether to replicate the local computing service has not yet been made is selected if the indexing scheme employs any other algorithm than incrementing the value of the index from the minimum.

If the decision on whether to replicate the local computing service corresponding to the current index value has not already been made, the process flow proceeds from step 425 to step 430. At step 430, an estimated cost of disruption to the selected local computing service for the expected duration of disruption can be computed. For example, such cost of disruption can include, but not limited to, the financial loss caused by service unavailability and the damage of reputation incurred by the organization offering the service and the provider of the IT infrastructure hosting the service.

Referring to step 432, an indexed list of CISP's can be generated based on specified criteria or business constraints such as cost for unit of resource, maximum resource capacity and infrastructure utilization. In general, before iterating the list of hosted services and candidate computational infrastructures (i.e., alternate CISP's), the list of available alternate CISP's can be sorted according to a set of criteria specified by the system administrator, or based on predefined programmed business constraints. For example, the list of available alternate CISP's can be sorted by decreasing order of availability, increasing order of cost or increasing likelihood of being affected by the weather event in consideration. The CISP index can be set to a minimum at step 432.

Referring to step 440, the replication time needed to replicate the selected local computing service employing the selected CISP can be calculated for the selected CISP, i.e., for the CISP corresponding to the current value for the CISP index.

Referring to step 445, the replication time calculated for the selected local computing service employing the selected CISP (the CISP corresponding to the current value of the CISP index) is compared with the expected time of initiation of disruption of the selected local computing service. A determination can be made as to whether there is enough time for replication, i.e., whether the replication time calculated for the selected local computing service employing the selected CISP is less than the expected time of initiation of disruption of the selected local computing service.

If there is not enough time for replication, the process flow proceeds to step 456, at which a determination is made as to whether the CISP index is at the maximum value. If the CISP index is not at the maximum value, i.e., if the CISP index can be incremented, the process flow proceeds to step 448, at which the CISP index is incremented to the next value. The process flow then proceeds to step 440 with the incremented value for the CISP index.

If the CISP index is at the maximum value at step 456, the process flow proceeds to step 459, at which a determination is made not to replicate the selected local computing service. The process flow then proceeds to step 466, at which a decision is made as to whether the index for the local computing services is at the maximum. Alternately, if the indexing scheme employs any other algorithm than incrementing the value of the index from the minimum, a determination can be made as to whether there exists any local computing service for which a determination on whether to replicate the local computing service has not yet been made.

If at step 466, it is determined that the index for the local computing services is at the maximum (or that decision on whether to replicate the local computing services have been made for all local computing services under consideration), the process flow then proceeds to step 499, at which the process flow terminates. If step 466 determines that the index for the local computing services is not at the maximum (or that there exists at least one local computing service for which a decision on whether to replicate needs to be made), the process flow proceeds to step 468, at which the index for the local computing service is incremented to the next value. The process flow then proceeds to step 425.

If a determination is made that there is enough time for replication at step 445, the process flow proceeds to step 450, at which the cost of replicating the selected local computing service to the selected CISP is computed.

Referring to step 452, the cost of restoring the local computing service from the selected CISP can be computed.

The total cost of replicating the selected local computing service to the selected CISP (which is one of the available alternate CISP's) under consideration includes the cost for replicating the selected local computing service to the selected CISP under consideration, and the cost for restoring the selected local computing service from the selected CISP under consideration.

Referring to step 455, a comparison is made between the total cost of replicating the selected local computing service to the selected CISP and the cost of disruption to the operator of the distributed computing infrastructure, i.e., the cost of disruption to the provider of the selected local computing service. It is noted that the operator of the distributed computing infrastructure may, or may not, be within the same company as the client of the selected local computing service.

If step 455 determines that the total cost of replicating the selected local computing service to the selected CISP is greater than the cost of disruption to the operator of the distributed computing infrastructure, the process flow proceeds to step 456. At step 456, a determination is made as to whether the CISP index is at the maximum value as described above, and the process flow proceeds to step 448 or to step 459 depending on whether the CISP index is at the maximum value.

If step 455 determines that the total cost of replicating the selected local computing service to the selected CISP is less than the cost of disruption to the operator of the distributed computing infrastructure, the process flow proceeds to step 460.

At step 460, a decision is made to replicate the selected local computing service to the selected CISP. The process flow then proceeds to step 466, at which a determination is made on whether the index for the local computing services is at the maximum (or that decision on whether to replicate the local computing services have been made for all local computing services under consideration) as described above. Depending on whether the index for the local computing services is at the maximum, the process flow proceeds to step 468 or to step 499.

Referring to operation 60 of FIG. 1 and step 600 of FIG. 2, the risk analysis module can be configured to instruct the service replication and computational infrastructure allocation module, through wired or wireless communication, to replicate the at least one local computing service if the expectation value is greater than the estimated total cost of replicating the at least one local device. Further, the risk analysis module can be configured to instruct the service replication and computational infrastructure allocation module, through wired or wireless communication, not to replicate the at least one local computing service if the expectation value is less than the estimated total cost of replicating the at least one local computing service.

If criteria for replicating the services are met, the risk analysis module can cause the service replication and computational infrastructure allocation module to perform a corresponding replication operation. Specifically, the information on what services need to be replicated where, as determined by the cloud selection module, can be passed on to the service replication and computational infrastructure allocation module. For example, the decisions made at step 460 and step 466 of FIG. 3B can be collected and forwarded to the service replication and computational infrastructure allocation module.

Referring to operation 70 of FIG. 1 and step 700 of FIG. 2, the service replication and computational infrastructure allocation module can allocate resources on the computational infrastructure sites to carry out the replication. Specifically, the service replication and computational infrastructure allocation module can be configured to receive instructions from the computational resource selection module and to add at least one selected CISP to the distributed computing infrastructure if the computational resource selection module generates an instruction to add the at least one selected CISP. The at least one local computing service can include any service that a distributed computing infrastructure can provide including, but not limited to: cloud application service, cloud platform service, and cloud infrastructure service. As discussed above, the cloud clients can include, but are not limited to, servers, notebooks, desktops, phones, and tablet PC's.

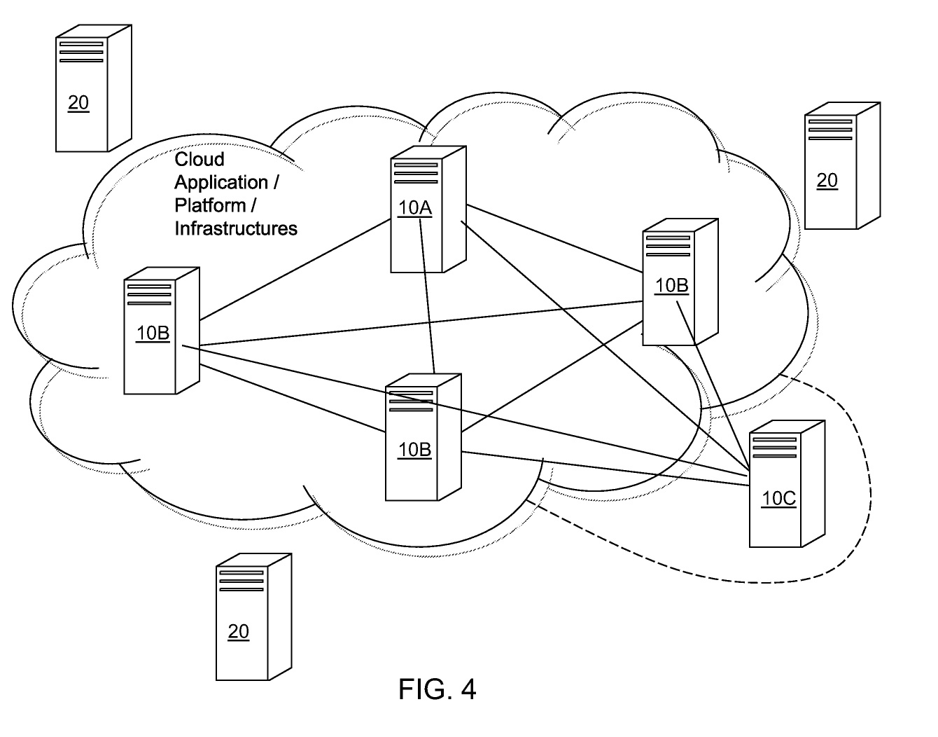

Referring to FIG. 4, a schematic diagram illustrates the expansion of a cloud infrastructure according to an embodiment of the present disclosure. A cloud (illustrated by a set of double sold lines) can include a set of cloud infrastructures. The set of cloud infrastructures can include a first type cloud infrastructure 10A that is affected by a predicted environmental event, i.e., that has a probability of not being able to provide a service during the predicted environmental event that is greater than a predefined threshold probability). The first type cloud infrastructure 10A can be located within a geographical region affected by the predicted environmental event, e.g., within a zone to be affected by severe weather conditions or in the expected path of a wildfire. The set of cloud infrastructures can include second type cloud infrastructures 10B that are not affected by the predicted environmental event.

The computational resource selection module of embodiments of the present disclosure can invoke a risk analysis module to determine whether to replicate the affected local computing services employing available alternate CISP's, i.e., available CISP's that are not part of the set of cloud infrastructures within the cloud. The available alternate CISP's are analyzed by the risk analysis module to determine a back-up CISP 10C into which a service is to be replicated, and to screen out unselected CISP's, which are not used to replicate services of the cloud. The back-up CISP 10C becomes part of an expanded cloud, which is represented by the set of double sold lines and the dotted line that encloses the back-up CISP 10C. In other words, the back-up CISP 10C is added as an additional cloud infrastructure to the cloud on a temporary basis until the probability of disruption of service due to the predicted environmental event is extinguished.

Referring to operation 80 of FIG. 1 and step 800 of FIG. 2, the service replication and computational infrastructure allocation module can update the information on the services hosted by the computational infrastructure provider, e.g., the addition of the back-up CISP 10C to the cloud on a temporary basis.

Referring to operation 90 of FIG. 1 and step 900 of FIG. 2, the service replication and computational infrastructure allocation module can update the information on the computational infrastructure availability.

The system including the computational resource selection module and the service replication computational infrastructure allocation module can be implemented independently of the physical sites for the infrastructures of the distributed computing infrastructure. Thus, the system including the computational resource selection module and the service replication computational infrastructure allocation module can be either at the site that requires the replication service or at any other location that contains all the required data to trigger the replication.

The following scenario is provided as an illustration of application of the method of an embodiment of the present disclosure. If a heavy storm is forecast for the next two days and the estimated impact area encloses one of a company's data center, the system of embodiments of the present disclosure can be employed to select the most appropriate data centre where the service provided by the company's affected data center, and to prevent disruption of the services provided by the company's data center.

While the disclosure has been described in terms of specific embodiments, it is evident in view of the foregoing description that numerous alternatives, modifications and variations will be apparent to those skilled in the art. Various embodiments of the present disclosure can be employed either alone or in combination with any other embodiment, unless expressly stated otherwise or otherwise clearly incompatible among one another. Accordingly, the disclosure is intended to encompass all such alternatives, modifications and variations which fall within the scope and spirit of the disclosure and the following claims.

1. A method of temporarily migrating services provided by a distributed computing infrastructure, said method comprising running a computer program on a system includes one or more processor units in communication with a memory, said computer program including steps of:
evaluating a risk, under at least one predicted environmental event, of not replicating at least one local computing service that an operator of said distributed computing infrastructure is expected to provide, wherein said at least one local computing service comprises at least one of infrastructure as a service (IaaS), platform as a service (PaaS), and software as a service (SaaS);
determining whether to replicate said at least one local computing service by adding at least one computing infrastructure service provider (CISP) to said distributed computing infrastructure based on said evaluating of said risk, wherein said evaluation of said risk comprises determining an estimated total cost of replicating said at least one local computing service for each of said at least one CISP, said estimated total cost of replicating comprising a cost for replicating said at least one local computing service to each selected CISP under consideration and a cost for restoring said at least one local computing service from said selected CISP under consideration;
temporarily migrating said at least one local computing service by adding at least one selected CISP to said distributed computing infrastructure if a determination to add said at least one selected CISP is made; and
restoring said at least one local service to said physical computing infrastructure when a probability of disruption of said at least one local computing service at said physical computing infrastructure is extinguished.

2. The method of claim 1, wherein said computer program further comprises a step of:
determining an impact of disruption of said at least one local computing service to said operator.

3. The method of claim 2, wherein said computer program further comprises a step of determining a probability at which that said at least one predicted environmental event is expected to disrupt said at least one local computing service.

4. The method of claim 2, wherein said computer program further comprises steps of:
computing an expectation value for a total financial cost of not replicating said local computing service; and
comparing said expectation value with said estimated total cost of replicating said at least one local computing service.

5. The method of claim 4, wherein said computer program further comprises steps of:
replicating said at least one local computing service if said expectation value is greater than said estimated total cost of replicating said at least one local device; and
not replicating said at least one local computing service if said expectation value is less than said estimated total cost of replicating said at least one local device.

6. The method of claim 2, wherein said estimated total cost of replicating further comprises
a cost of operating each selected CISP under consideration for a duration of said at least one predicted environmental event.

7. The method of claim 1, wherein said computer program further comprises steps of:
generating a list of available alternate CISP's for each selected local computing service among said at least one local computing service; and
computing a replication time needed to replicate said selected local computing service for each available alternate CISP among said list of available alternate CISP's.

8. The method of claim 7, wherein said computer program further comprises a step of computing an estimated time until initiation of a possible disruption due to said at least one predicted environmental event.

9. The method of claim 8, wherein said computer program further comprises a step of determining an estimated total cost of replicating said at least one local computing service only for available alternate CISP's having a replication time that is less than said estimated time until initiation of said possible disruption.

10. The method of claim 1, wherein said computer program further comprises a step of computing an estimated duration of a possible disruption from at least one predicted environmental event.

11. The method of claim 10, wherein said computer program further comprises a step of determining an estimated total cost of replicating said at least one local computing service based on said computed estimated duration of said possible disruption.

12. The method of claim 1, wherein said computer program further comprises steps of, for each selected local computing service among said at least one local computing service:
generating a list of available alternate CISP's; and
computing a minimum total cost of replicating said selected local computing service employing an alternate CISP among said list of available alternate CISP's.

13. The method of claim 12, wherein said minimum total cost is calculated by:
calculating, for each available alternate CISP among said list of available alternate CISP's, a total cost of replicating said selected local computing service employing said each available alternate CISP; and
selecting a minimum value among said calculated total costs of replicating said selected local computing service.

14. (canceled)

15. The method of claim 1, wherein said computer program further comprises a step of, for each selected local computing service among said at least one local computing service, generating an indexed list of available alternate CISP's based on predetermined specified criteria or predetermined business constraints.

16. The method of claim 15, wherein said computer program further comprises steps of:
setting an initial value for an index for said indexed list of available alternate CISP's at an extremum; and
incrementing or to decrementing said index until an available alternate CISP is found that is capable of providing said selected local computing service at a total cost of replicating said selected local computing service that is less than an expectation value for a total financial cost of not replicating said local computing service or until all CISP's within said indexed list of available alternate CISP's are examined.

17. The method of claim 1, wherein said computer program further comprises a step of monitoring information on services hosted by said operator.

18. The method of claim 1, wherein said computer program further comprises a step of determining availability of said at least one local computing service under said at least one predicted environmental event.

19. The method of claim 18, wherein said computer program further comprises a step of determining whether an estimated probability of disruption of said at least one local computing service is greater than a predefined value.

20. The method of claim 1, wherein said computer program further comprises a step of monitoring information on available infrastructures of said distributed computing infrastructure.

21. The method of claim 1, wherein said at least one local computing service comprises at least one of cloud application service, cloud platform service, and cloud infrastructure service.

22. The method of claim 1, wherein said at least one predicted environmental event comprises weather events.

23. The method of claim 1, wherein said at least one predicted environmental event comprises a geothermal activity, a geomechanical activity, or a natural phenomenon derived from a geothermal activity or a geomechanical activity.

24. The method of claim 1, wherein said at least one predicted environmental event comprises a man-made event that disrupts operation of at least one component of said distributed computing infrastructure.

25. A non-transitory machine readable data storage medium embodying a computer program for dynamically provisioning resources for a distributed computing infrastructure, said computer program includes instructions for performing steps of:
evaluating a risk, under at least one predicted environmental event, of not replicating at least one local computing service that an operator of said distributed computing infrastructure is expected to provide, wherein said at least one local computing service comprises at least one of infrastructure as a service (IaaS), platform as a service (PaaS), and software as a service (SaaS);
determining whether to replicate said at least one local computing service by adding at least one computing infrastructure service provider (CISP) to said distributed computing infrastructure based on evaluation of said risk, wherein said evaluation of said risk comprises determining an estimated total cost of replicating said at least one local computing service for each of said at least one CISP, said estimated total cost of replicating comprising a cost for replicating said at least one local computing service to each selected CISP under consideration and a cost for restoring said at least one local computing service from said selected CISP under consideration;
temporarily migrating said at least one local computing service by adding at least one selected CISP to said distributed computing infrastructure if a determination to add said at least one selected CISP is made; and
restoring said at least one local service to said physical computing infrastructure when a probability of disruption of said at least one local computing service at said physical computing infrastructure is extinguished.
